(19) United States
(12) Patent Application Publication
(10) Pub. No.: US 2007/0199941 A1
(43) Pub. Date: Aug. 30, 2007

(54) Method and appartus for storing cryogenic media

(75) Inventor: Wilfried-Henning Reese, Unterschleissheim (DE)

Correspondence Address: CROWELL & MORING LLP;INTELLECTUAL PROPERTY GROUP, P.O. BOX 14300, WASHINGTON, DC, 20044-4300, US

(73) Assignee: Linde Aktiengesellschaft, Wiesbaden (DE)

(21) Appl. No.: 11/660,580

(22) PCT Filed: Aug. 4, 2005
(86) PCT No.: PCT/EP05/08475

§ 371 Date: Feb. 16, 2007

(30) Foreign Application Priority Data
Aug. 17, 2004 (DE) 10 2004 039 840.2

(51) Int. Cl. F17C 3/08; F17C 7/04; F17C 13/00

(52) U.S. Cl. 220/560.1; 62/45.1; 62/48.1; 220/560.04

(57) ABSTRACT

A storage tank, specifically a storage tank for low-temperature fluids, preferably for liquid hydrogen, having an outer tank, at least one inner tank, insulation having at least one metal layer located between the outer tank and the inner tank or tanks, and two or more process lines, is disclosed. The, or at least two of the process lines have means to vent evaporated, low-temperature fluid from the inner tank or tanks. The means to vent evaporated, low-temperature fluid are configured such that they enable the quantity of gas to be vented to be controlled.

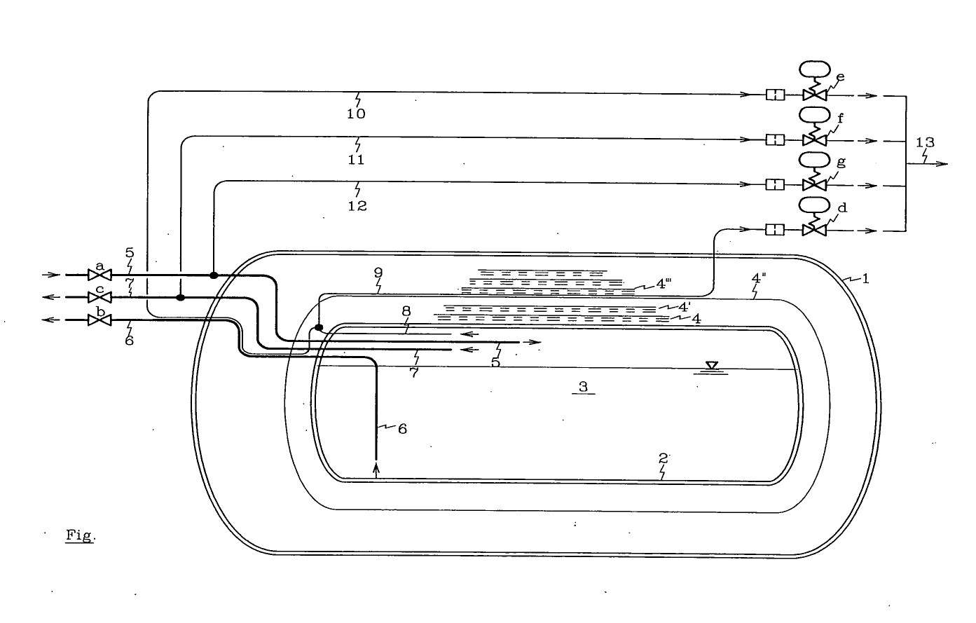

This application claims the priority of International Application No. PCT/EP2005/008475, filed Aug. 4, 2005, and German Patent Document No. 10 2004 039 840.2, filed Aug. 17, 2004, the disclosures of which are expressly incorporated by reference herein.

### BACKGROUND AND SUMMARY OF THE INVENTION

The invention relates to a storage tank, specifically a storage tank for low-temperature fluids, preferably for liquid hydrogen, having an outer tank, at least one inner tank, insulation located between the outer tank and the inner tank or tanks, at least one metal layer and two or more process lines.

The term “process line(s)” should be understood to mean all lines leading through the outer tank, located on the inner tank or tanks through which the inner tank, or tanks, are filled with a medium or by way of which a medium is removed from the inner tank or tanks.

In what follows the letters “G” for “gaseous” and “L” for “liquid” are placed in front of the designations of special cryogenic media according to their aggregate state; thus, for example, GH₂ or LH₂ for gaseous or liquid hydrogen.

Hydrogen in particular is increasingly gaining in importance as a source of energy as a result of the rising need for energy and heightened environmental awareness. Already trucks, buses and passenger cars are being propelled by hydrogen-powered engines or fuel cells. Besides this, initial experiments are in progress to power airplanes with the media named.

Storage of the hydrogen “on board” the above named forms of transportation is most expedient in liquid form. It is true that the hydrogen has to be cooled to about 21 K and maintained at this temperature—which can only by done by taking appropriate insulating measures on the storage containers or tanks—but storage in gaseous form in the above named forms of transportation is more disadvantageous because of the low density of GH₂ since the gas must be stored in large-capacity, heavy storage tanks at high pressures.

If no medium is removed from such storage tanks over an extended period, a temperature and pressure increase takes place inside the interior tank in the medium stored in it because of the unavoidable intrusion of heat from the environment into the inner tank. Depending on the design pressure of the interior tank, gaseous medium must be vented or blown off from time to time from the storage tank by way of a filler and/or extraction line in which, for example, a pressure relief valve is provided. If the storage tank is intended for a vehicle, this quantity of the gaseous medium is lost unused unless an additional storage device, as for example, a metal hydride tank is provided for the gas or medium to be vented.

Conventional storage tanks for liquid hydrogen allow parking times of two to three days before evaporation and thus loss of gaseous hydrogen occurs. The acceptance of hydrogen as an energy source—particularly in the case of passenger cars—will depend, among other things, on the potential length of the parking time of a passenger car. Venting hydrogen after two to three days will certainly not be accepted by the customer.

The insulation of storage tanks which are used for the storage of cryogenic fluids or media is usually achieved by what is known as super-insulation. This consists of several layers of thin aluminum film and/or aluminum-vaporized film with a fiberglass mat between them or a layer of a fiberglass non-woven. The fiberglass mat, or fiberglass non-woven layer prevents the aluminum films and/or aluminum vaporized films from touching each other and thus triggering a thermal short circuit.

It has already been suggested in addition to locate an aluminum or copper shield, which usually completely surrounds the inner tank, inside the intermediate space of storage tanks of a generic type at a specific temperature level and to spot weld it thermally with a extraction line by way of which the evaporated cryogenic medium is drawn off from the inner tank. This aluminum or copper shield is then (re)cooled by the escaping cryogenic medium each time cryogenic medium is vented. The heat stream intruding from the environment up to that temperature level at which the aluminum or copper shield is set is absorbed by the heating of the cryogenic medium to be vented and routed outside again. The heat stream onto the inner tank can thereby be substantially reduced. In principle several aluminum or copper shields can be provided, which further improves the insulating effect. However, the expense for designing such storage tanks is considerable.

A generic storage tank for cryogenic media is known from the unpublished German patent application 103 53 382. In the case of this tank, at least one of the filling and/or extraction lines is in direct and/or indirect thermal contact with the metal layer or layers of the (super)insulation located between the outer and inner tank. For technical reasons, such a design is frequently not realizable or realizable only at a disproportionately high cost.

In order to transmit heat, the lines to be cooled must be in heat conducting contact over a specific length against the shield, or the metal layer or layers respectively, so that heat transfer can take place. This heat conducting contact is achieved by soldering the parts to be in contact or bonding with heat-conducting adhesive. These processes demand considerable time during the manufacturing process. In addition, the continuous manufacturing process is interrupted by these measures. In addition for design reasons, the process lines can frequently not be in contact over the requisite length since the necessary space is not available in the insulating space.

The object of the present invention is to specify a generic storage tank in which the heat intruding into the medium stored in the tank is reduced and which, using simple means, permits a clear reduction in the quantity of medium to be vented.

To achieve this object, a storage tank is proposed whose features are that the or at least two of the process lines have means to vent evaporated, low-temperature fluid from the inner tank or tanks.

In accordance with the invention, both—inasmuch as only two process lines are provided—or at least two of the process lines have suitable means to vent evaporated, low-temperature fluid—the gas produced by heat intruding on the inner tank; the consequence is that these process lines, by way of which a not inconsiderable heat intrusion into the inner tank or tanks occurs, are re-cooled by cold gas with each venting.

Refining the storage tank in accordance with the invention, it is provided that the means to vent evaporated, low-temperature fluid are configured such that they permit management of the quantity of gas to be vented.

If venting should take place, for example, over two process lines having two different lengths which do not differ otherwise, the aforementioned embodiment permits a greater quantity of gas to be vented over the shorter process line by way of which more heat enters into the inner tank than over the longer of the two process lines.

In accordance with an advantageous embodiment of the storage tank in accordance with the invention, the means for venting evaporated, low-temperature fluid are preferably configured as valves, specifically overflow valves and/or restrictors.

Refining the storage tank in accordance with the invention, one or more additional vent lines can be provided in addition to the process lines, where the lines similarly have means to vent, preferably the controlled venting of evaporated, low-temperature liquid.

The aforementioned additional vent lines are preferably in direct and/or indirect thermal contact with one or more process lines.

Direct thermal contact can, for example, be made by means of a metal adhesive band, a heat conducting adhesive and/or a heat conducting paste. However, an adequate transfer of the required cooling energy from the additional vent lines to the process lines can be accomplished by means of indirect thermal contact, by means of the transfer of thermal energy by radiation.

Such additional vent lines can—compared with the process lines—be designed with smaller diameters since the volume of vented medium is considerably reduced with the storage tank in accordance with the invention compared with the storage tank designs numbered among the prior art.

Expressed in simplified form, it can be said that the storage tank in accordance with the invention has more “vent paths or possibilities”; the consequence is that the volume of vented gas—compared with the storage tank designs numbered among the prior art—is reduced since the heating energy of the vent gas, or the vent gas streams, can be better utilized.

In principle, the volume of gas to be vented over process lines and additional vent lines to be provided as required can be regulated separately for each of the aforementioned lines. This allows the volume of gas to be vented to be optimally adjusted to the line parameters, such as material, length, etc.

Therefore, a management system is preferably to be provided which serves to coordinate and regulate the vent streams or quantities over the different vent paths.

The achievement of the invention is that the volume of evaporated cryogenic medium is reduced or becomes negligibly small so that this previously described disadvantage should not stand in the way of acceptance, specifically of the medium hydrogen. If, for example, a vehicle with a storage tank in accordance with the invention is provided with an additional metal hydride tank, it can capture and store the small quantity of medium to be vented.

The storage tank in accordance with the invention is particularly suitable for use as a mobile storage tank, preferably as a storage tank for vehicles of any type.

The storage tank in accordance with the invention and further embodiments of the same are to be explained in what follows using the embodiment shown in the drawing.

### BRIEF DESCRIPTION OF THE DRAWING

The drawing shows in schematic representation a side section through a storage tank for low-temperature fluids, such as for example, liquid hydrogen.

### DETAILED DESCRIPTION OF THE DRAWING

A storage tank of this kind—such as is used, for example, in vehicles powered by liquid hydrogen—has an outer tank 1, an inner tank 2 in which the medium 3 to be stored is found and several layers of metal 4, 4′, 4″, 4′″, . . . located between the outer tank 1 and the inner tank 2; the latter forming the required (super)insulation.

The storage tank shown additionally has three process lines, a filler line 5, over which the medium to be stored is brought to the inner tank 2, and two extraction lines 6 and 7 through which liquid, or gaseous, medium can be drawn off. A shut-off valve a, b or c is provided in each of the aforementioned process lines 5, 6 and 7.

Provision is made further for an additional vent line 8 through which gaseous medium formed in the gas chamber of the inner tank 2 can be drawn off. This vent line 8 is divided into a vent line 9 which is in thermal contact with aforementioned metal layers 4, 4′, 4″ . . . and a vent line 10 which is in thermal contact with the discharge line 6. Vent lines 11 or 12 are assigned in addition to the filler line 5 and the discharge line 7.

The aforementioned vent lines 9 to 12 each have a control valve d, e, f or g by means of which the quantity of gas flowing out over the specific vent line can be regulated. The quantities of gas flowing out over the aforementioned vent lines are brought together in the collector line 13 and vented to atmosphere and/or taken for further use, as for example, for further use in a fuel cell to generate electrical energy which assists the vehicle's electrical power supply. Since the anticipated quantity is very small, the vent quantity can be converted into water through catalytic reaction or combustion with an air-oxygen mixture and discharged to the environment.

By means of a suitable management system, gaseous medium can be removed selectively from the gas chamber of the inner tank 2 over the filler line 5/vent line 12, the extraction line 7/vent line 11 and/or the vent lines or line sections 8, 9 and 10; the aforementioned lines and one or more of the metal layers of the insulation 4, 4′, 4″, . . . are cooled by this and through vent line 9, whereby the desired reduction of heat intruding from the environment into the stored medium is reduced.

1-7. (canceled)

8. A storage tank for a low-temperature fluid, having an outer tank, an inner tank, a metal insulation layer located between the outer tank and the inner tank, and two process lines, wherein the process lines include means to vent evaporated, low-temperature fluid from the inner tank.

9. The storage tank according to claim 8, wherein the low-temperature fluid is liquid hydrogen.

10. The storage tank according to claim 8, wherein the means to vent evaporated, low-temperature fluid are configured such that they permit regulation of a quantity of the evaporated, low-temperature fluid to be vented.

11. The storage tank according to claim 8, wherein the means to vent evaporated, low-temperature fluid are configured as valves and/or baffles.

12. The storage tank according to claim 8, wherein a vent line is provided to vent the evaporated, low-temperature fluid.

13. The storage tank according to claim 12, wherein the vent line is in direct and/or indirect thermal contact with the metal insulation layer.

14. The storage tank according to claim 12, wherein the vent line is in direct and/or indirect thermal contact with at least one of the process lines.

15. The storage tank according to claim 8, wherein the storage tank is included in a vehicle.

16. Use of a storage tank according to claim 8 as a mobile storage tank.

17. The use of a storage tank according to claim 16, wherein the storage tank is used in a vehicle.

18. A storage tank for a low-temperature fluid, comprising:
an outer tank;
an inner tank;
a metal insulation layer disposed between the outer tank and the inner tank; and
two process lines, wherein each of the process lines include a vent and wherein evaporated, low-temperature fluid is vented from the inner tank through the vents.

19. The storage tank according to claim 18, wherein one of the two process lines supplies the fluid to the inner tank and wherein the other of the two process lines removes the fluid from the inner tank.

20. The storage tank according to claim 18, further comprising a first vent line, wherein the first vent line vents evaporated, low temperature fluid from the inner tank and wherein the first vent line is in thermal contact with the metal insulation layer.

21. The storage tank according to claim 20, wherein the first vent line cools the metal insulation layer by the evaporated, low temperature fluid vented from the inner tank by the first vent line.

22. The storage tank according to claim 20, further comprising a second and a third vent line, wherein the second and third vent lines vent evaporated, low temperature fluid from the inner tank, wherein the second vent line is in thermal contact with one of the two process lines, and wherein the third vent line is in thermal with the other of the two process lines.

23. The storage tank according to claim 22, wherein one of the two process lines supplies the fluid to the inner tank and wherein the other of the two process lines removes the fluid from the inner tank.

24. A method for controlling evaporation of a low-temperature fluid stored in a storage tank, comprising the steps of:
venting evaporated, low-temperature fluid from the storage tank through two process lines, wherein one of the two process lines supplies the fluid to the tank and wherein the other of the two process lines removes the fluid from the tank.

25. The method according to claim 24, further comprising the step of venting evaporated, low-temperature fluid from the storage tank through a first vent line, wherein the first vent line is in thermal contact with a metal insulation layer disposed between an inner tank and an outer tank of the storage tank.

26. The method according to claim 25, further comprising the steps of venting evaporated, low-temperature fluid from the storage tank through a second and a third vent line, wherein the second vent line is in thermal contact with one of the two process lines, and wherein the third vent line is in thermal contact with the other of the two process lines.

27. The method according to claim 26, wherein the first vent line cools the metal insulation layer and wherein the second and third vent lines cool the respective process lines.
